(19) United States
(12) Patent Application Publication
(10) Pub. No.: US 2006/0023936 A1
(43) Pub. Date: Feb. 2, 2006

(54) Film detection apparatus for detecting organic film formed on printed circuit board, inspection system, and method of inspecting printed circuit board

(75) Inventor: Nariaki Fujiwara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/190,876

(22) Filed: Jul. 28, 2005

(30) Foreign Application Priority Data
Jul. 29, 2004 (JP) JP2004-221743

(51) Int. Cl. G06K 9/00

(52) U.S. Cl. 382/149

(57) ABSTRACT

Functional elements including a data processing part and a detection part are implemented by a computer. The data processing part accepts inputs including threshold information obtained by experiment from an acceptable printed circuit board and a sample printed circuit board and information for identifying an inspection region to generate characteristic data and inspection region data. The detection part references the inspection region data to thereby select pixels corresponding to the inspection region among the pixels constituting captured image data about a printed circuit board to be inspected. The detection part then calculates a measured value from the pixel values of the selected pixels to compare the calculated measured value with a threshold value included in the characteristic data, thereby detecting an organic film in accordance with a result of the comparison. This reduces burdens on an operator during the inspection of the printed circuit board for the organic film to achieve the high-precision inspection.

### BACKGROUND OF THE INVENTION

1. Field of the Invention

The present invention relates to a technique for inspecting a board, particularly a printed circuit board, for an organic film formed thereon.

2. Description of the Background Art

A bonding pattern including a plurality of bonding pads on a printed circuit board has been made of gold (Au) because of its stability against change with time and its superiority in conductivity. In recent years, however, solder free of lead (Pb) has come into use to meet a request for environmental protection, and attention has been given to copper (Cu) excellent in adhesion to the lead-free solder as a material of the bonding pattern.

Unfortunately, copper has the disadvantage of being more easily oxidized than gold when exposed to the air to result in degradation in the adhesion to solder. To overcome the disadvantage in a present-day printed circuit board, an organic film is formed on the bonding pattern of copper to protect the bonding pattern. Thus, the organic film is essential as an antioxidant film for a printed circuit board employing the bonding pattern of copper.

As mentioned above, a printed circuit board with the organic film improperly formed on the bonding pattern becomes a defective because copper is oxidized. Such a defect in the printed circuit board, which results from change with time, principally emerges after the shipment thereof. It is impossible for a go/no-go test executed in a manufacturing plant immediately after the manufacture to detect a defect in the bonding pattern. Thus, a need arises to perform an inspection to detect the state of the organic film (especially the presence/absence of the organic film) in the manufacturing plant for printed circuit boards.

Methods of inspection for such an organic film have been proposed. Examples of the methods include a method of measuring a film thickness which utilizes mutual interference between light reflected from the surface of the board and light reflected from the surface of the organic film, and a method of destructive measurement which directs electrons toward the organic film. The surface of the bonding pattern on the printed circuit board is not a flat surface but is previously moderately roughened to enhance the adhesion to the solder, thereby diffusely reflecting the light directed thereon. It is therefore impossible to apply the method which utilizes the interference of light because the reflecting surfaces of the objects (the surface of the organic film and the surface of the board) must be relatively even. For the destructive measurement, only a sampling inspection can be performed, but a 100% inspection cannot be performed.

A technique for meeting the requirement for the 100% inspection has been proposed. An example of such a technique includes previously directing white light onto a board (iron plate) with the organic film formed thereon to measure reflectances for respective wavelengths, and comparing the reflectances for the respective wavelengths with the spectral reflectance of reflected light from a board to be inspected to measure a film thickness. This technique, however, presents a problem such that only a single specific spot on the board can be inspected each time a measurement is made. Each of the bonding pads of the bonding pattern has, for example, an area of about 300 μm in diameter, and will be useless unless this area is properly covered. Thus, a predetermined area in which the bonding pattern is formed is to be inspected, and the inspection of other positions is useless. Even if the predetermined area is inspected, there is another problem in that the organic film cannot be judged to be formed properly from the fact that the proper organic film happens to be formed only at a single specific spot within the area. A conceivable solution to this problem is to perform the inspection a plurality of times. This, however, is a very cumbersome process since a plurality of measurements must be made on a single bonding pad, and an optical system and the board must be moved relative to each other for each of the measurements. A still another problem arises such that the measurement of the spectral reflectance and the like necessitates the preparation of a huge optical system to give rise to increased costs of a film detection apparatus.

There has been proposed a method of measuring the contact angle between the wall of a drop of liquid placed on the printed circuit board and the surface of the printed circuit board by obtaining the image of the drop. Such a method can detect the thickness of the organic film within some range by defining the sectional area of the drop as the area of a bonding pad. Such measurement, however, uses a certain liquid dropped onto the printed circuit board to involve a need for the step of cleaning and drying the liquid after the inspection. Additionally, there is a need to drop a suitable amount of liquid in a desired position, and it is almost impossible to inspect the bonding pads disposed all over the printed circuit board one by one. This method presents a still another problem such that the shape of the drop is limited to a generally circular shape as viewed in plan view due to the surface tension thereof, and is not always identical with the shape of the bonding pads.

With the current state of the art, an operator visually checks the bonding pads on the printed circuit board one by one under a microscope to identify the state of the organic film on the bonding pads.

The visual inspection of all of the bonding pads is a burdensome operation for the operator because the bonding pads on the printed circuit board are enormous in number. Further, this operation requires the skill of the operator because of difference in vision depending on the material and characteristics of the organic film, the state of the printed circuit board (the roughness of the surface of the bonding pattern) and the like. This makes it difficult to provide uniform inspection results. Moreover, a present-day trend is toward the reduction in the thickness of the organic film due to a request for reduction in organic material to be used. Therefore, visual evaluation has limitations.

### SUMMARY OF THE INVENTION

The present invention is directed to a technique for inspecting a board, more specifically a printed circuit board, for an organic film formed thereon.

A first aspect of the present invention is intended for a film detection apparatus for detecting an organic film formed on a printed circuit board formed with a pattern. The film detection apparatus comprises: a storage element for previously storing characteristic information serving as a reference; a holding element for holding an objective printed circuit board to be inspected; an illumination element for directing illuminating light onto the objective printed circuit board held by the holding element; an image capturing element for capturing an image of the objective printed circuit board irradiated with the illuminating light to provide two-dimensional image data; a detection element for detecting the organic film based on the image data provided from the image capturing element and the characteristic information stored in the storage element; and an output element for outputting a result of the detection of the detection element to an operator.

The film detection apparatus detects the organic film based on objective information to achieve a uniform and precise inspection. Additionally, the film detection apparatus reduces operating burdens on the operator because the operator is required only to view the outputted detection result.

Preferably, the detection element measures the thickness of the detected organic film in accordance with the pixel values or the measured value.

This enables the operator to flexibly respond to an inspection result, e.g. to effect the feedback control of the step of forming the organic film in accordance with the measured thickness, as compared with a technique for detecting only the presence or absence of the organic film.

The present invention is also intended for a method of inspecting a printed circuit board. The method comprises the steps of: (a) causing a pattern inspection apparatus to detect a pattern formed on a printed circuit board; (b) generating inspection region information, the inspection region information being information about the pattern detected in the step (a); (c) transmitting the inspection region information generated in the step (b) from the pattern inspection apparatus to a film detection apparatus; and (d) causing the film detection apparatus to detect whether or not an organic film is formed on the pattern detected by the pattern inspection apparatus, based on the inspection region information transmitted in the step (c), the step (d) including the steps of: (d-1) previously storing characteristic information serving as a reference; (d-2) holding an objective printed circuit board to be inspected; (d-3) directing illuminating light onto the objective printed circuit board held in the step (d-2); (d-4) capturing an image of the objective printed circuit board irradiated with the illuminating light to provide two-dimensional image data; (d-5) detecting the organic film based on the image data provided in the step (d-4), the characteristic information stored in the step (d-1), and the inspection region information; and (d-6) outputting a result of the detection provided in the step (d-5) to an operator.

Information required for the inspection in the film detection apparatus can be obtained from the pattern inspection apparatus upstream thereof. Thus, the method reduces the number of items specified by the operator to accordingly reduce the burdens on the operator.

It is therefore an object of the present invention to achieve a high-precision inspection while reducing burdens on an operator.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the construction of a film detection apparatus according to a first preferred embodiment of the present invention;

FIG. 2 is a bus wiring diagram principally in a computer;

FIG. 3 is a diagram showing functional blocks implemented by the operation of a CPU in accordance with a program together with data flows according to the first preferred embodiment;

FIG. 4 is a flow chart showing the operation of the film detection apparatus;

FIG. 5 is a flow chart showing a detection process in the film detection apparatus;

FIG. 6 shows a reflection characteristic obtained when white light is directed onto an organic film formed on a pattern region;

FIG. 7 shows examples of bonding pads formed on a printed circuit board;

FIG. 8 shows a pixel value obtained when no organic film is formed;

FIG. 9 shows the pixel value obtained when an organic film having a thickness of 0.2 μm is formed;

FIG. 10 shows the pixel value obtained when an organic film having a thickness of 0.3 μm is formed;

FIG. 11 shows a relationship between the amount of reflection of a blue light component and a film thickness value;

FIG. 12 shows the construction of the film detection apparatus according to a second preferred embodiment of the present invention;

FIG. 13 shows the construction of the film detection apparatus according to a third preferred embodiment of the present invention;

FIG. 14 shows the construction of an inspection system according to a fourth preferred embodiment of the present invention;

FIG. 15 is a front view of the film detection apparatus according to the fourth preferred embodiment;

FIG. 16 is a side view of the film detection apparatus according to the fourth preferred embodiment;

FIG. 17 is a block diagram showing the construction of the film detection apparatus according to the fourth preferred embodiment;

FIG. 18 is a diagram showing functional blocks implemented by the operation of the CPU of the film detection apparatus in accordance with a program together with data flows according to the fourth preferred embodiment;

FIGS. 19 through 21 are flow charts principally showing the operation of the film detection apparatus in the inspection system according to the fourth preferred embodiment; and

FIG. 22 shows the positioning of a two-dimensional CCD camera according to a modification of the present invention.

### DESCRIPTION OF THE PREFERRED EMBODIMENTS

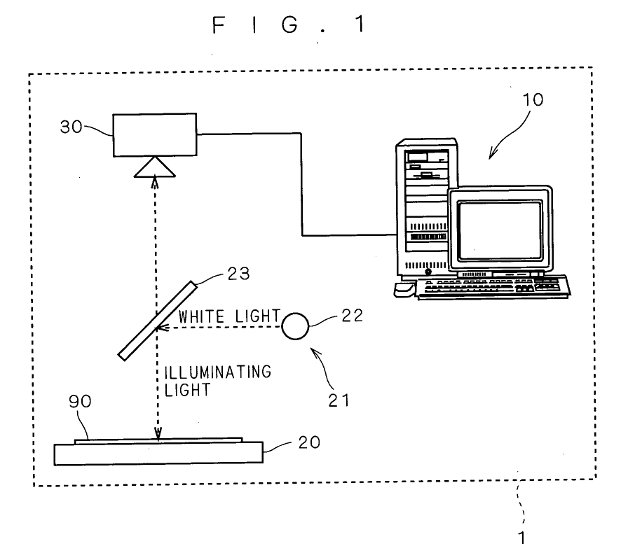

FIG. 1 shows the construction of a film detection apparatus 1 according to a first preferred embodiment of the present invention. The film detection apparatus 1 includes a computer 10, a table 20, an illumination system 21, and a two-dimensional CCD camera 30. The film detection apparatus 1 having such a construction functions as an apparatus for inspecting a printed circuit board 90 for an organic film formed thereon.

The organic film is formed as a solderable protective film for preventing the oxidation of a bonding pattern including a plurality of bonding pads formed on a printed circuit board. The organic film used herein is made of an azole derivative and the like, such as imidazole, benzimidazole, benzotriazole or alkyl imidazole. The material of the organic film is not limited to the these materials if the material satisfies the above-mentioned condition. Copper is used as an example of the material of the bonding pattern in this preferred embodiment. The material forming the bonding pattern, however, is not limited to copper, but may be other metals such as silver, iron or aluminum. Preferably, the material of the bonding pattern used herein can be provided in the form of a thin film and has good adhesion to lead-free solder and good conductivity.

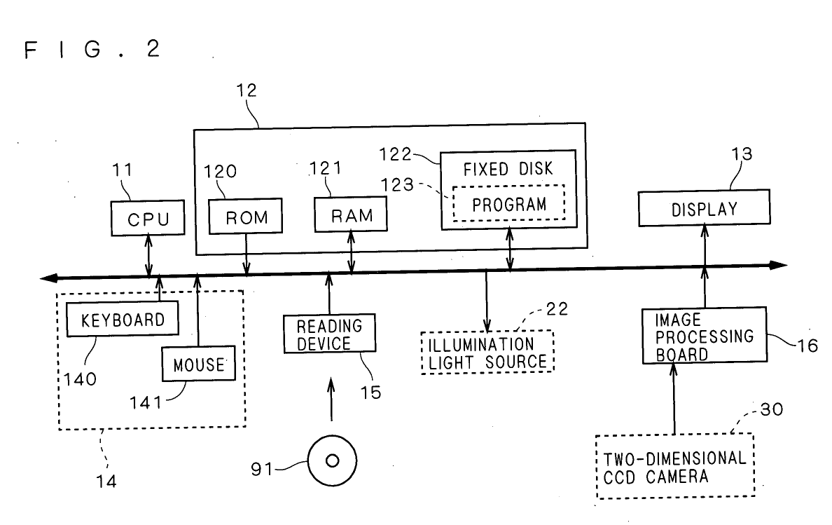

FIG. 2 is a bus wiring diagram principally in the computer 10. The computer 10 is a device substantially similar in function and construction to a typical personal computer. The computer 10 includes a CPU 11, a storage device 12, a display 13, a manipulation part 14, a reading device 15 and an image processing board 16 which are connected to each other through bus wiring, as shown in FIG. 2.

The CPU 11 operates in accordance with a program 123 to have the functions of computing various data and generating a control signal for controlling other constituents. The storage device 12 includes a ROM (read-only memory) 120, a RAM 121 used as a temporary working area for the CPU 11, and a fixed disk 122. The storage device 12 is a device in which various data and the program 123 are stored as appropriate.

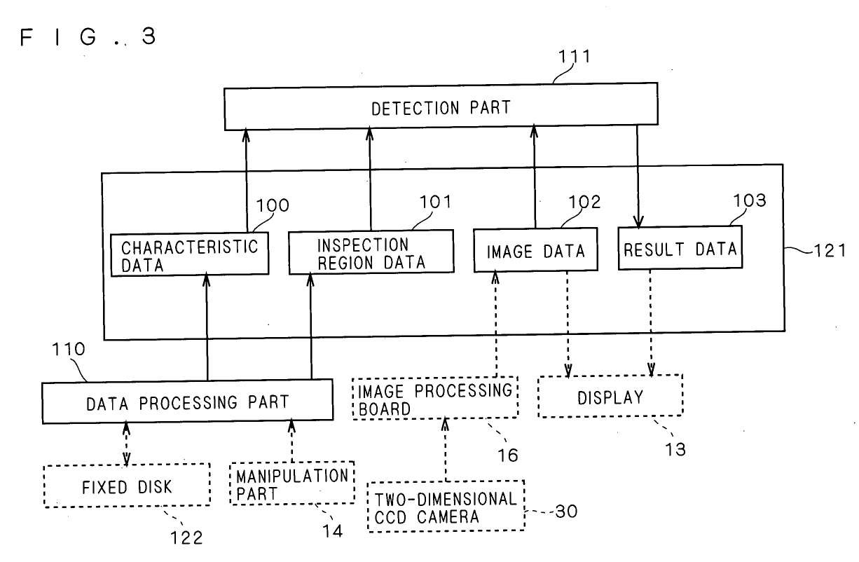

FIG. 3 is a diagram showing functional blocks implemented by the operation of the CPU 11 in accordance with the program 123 together with data flows. A data processing part 110 and a detection part 111 shown in FIG. 3 are the functional blocks implemented by the CPU 11.

The data processing part 110 generates characteristic data 100 based on an input from the manipulation part 14 to store the characteristic data 100 in the fixed disk 122. The data processing part 110 also has the function of reading out the characteristic data 100 previously stored in the fixed disk 122 to the RAM 121 in response to an input from the manipulation part 14. The characteristic data 100, which will be described in detail later, is information principally about the characteristics of printed circuit boards (including an objective printed circuit board 90) to be inspected by the film detection apparatus 1 and the organic film formed on the printed circuit boards, and is information serving as a reference for judgment about the state of the organic film.

The data processing part 110 also generate inspection region data 101 including information about the position, shape and size of an inspection region, based on an input from the manipulation part 14.

The term “inspection region” used herein means a region in which the objective printed circuit board 90 is inspected for the presence/absence of the organic film thereon (or a region in which the organic film is to be detected). Thus, the inspection region is a region in which a bonding pad of the bonding pattern formed on the objective printed circuit board 90 is principally present (referred to hereinafter as a pattern region). In general, a plurality of bonding pads of the bonding pattern are formed on the objective printed circuit board 90. Accordingly, a plurality of inspection regions are present on the single objective printed circuit board 90. It should be noted that the inspection region does not always coincide with the pattern region if there is no need to inspect all of the bonding pads for the organic film or if a uniform organic film is formed all over the objective printed circuit board 90.

The detection part 111 initially references the inspection region data 101 to identify pixels corresponding to the inspection region among all of the pixels contained in image data 102. Next, the detection part 111 obtains the pixel values of the identified pixels from the image data 102 to calculate a measured value, and then compares the calculated measured value with a threshold value W indicated in characteristic data 100 to judge the presence or absence of the organic film in the inspection region. If the organic film is present, the detection part 111 judges (measures) the thickness of the organic film. Further, the detection part 111 generates result data 103 based on the presence or absence (detection result) of the organic film in the inspection region and the thickness of the organic film.

Referring again to FIG. 2, the display 13 is a display device for displaying various data on the screen thereof to an operator, and corresponds to a liquid crystal display and the like. In particular, the display 13 displays the image data 102 and outputs and displays the result data 103 on the screen to the operator.

An output element may be a printing apparatus for printing the result data 103 on a sheet of paper, or may be an alarm lamp and a buzzer for indicating an error (the defect of the organic film). Thus, the output element may be of any mechanism or structure if the output element can at least inform the operator whether the objective printed circuit board 90 (or the organic film) is defective or not.

The manipulation part 14 includes a keyboard 140 and a mouse 141, and is used when the operator inputs an instruction to the film detection apparatus 1. The manipulation part 14 is also used when the information on which the characteristic data 100 and the inspection region data 101 are based is inputted as described above, as well as when the instruction is inputted. The manipulation part 14 may include a touch panel which doubles as the display device, a variety of buttons, or a scanner having an OCR capability. Further, the manipulation part 14 may be a combination of the above-mentioned components.

The reading device 15 is a device for reading various data from a disk 91 which is a portable recording medium. The various data read by the reading device 15 is transferred to and recorded on the fixed disk 122 and the RAM 121 as appropriate. The film detection apparatus 1, for example, reads the disk 91 with the program 123 recorded thereon by means of the reading device 15 to transfer and store the program 123 to and in the fixed disk 122.

The image processing board 16 generates the image data 102 composed of the pixel values of each two-dimensional array of pixels in response to a signal inputted from the two-dimensional CCD camera 30 to transfer the image data 102 to the RAM 121. For purposes of convenience, an output from the two-dimensional CCD camera 30 is also referred to as the image data 102 in the description below.

Referring again to FIG. 1, the table 20 has the function of holding the objective printed circuit board 90 in a predetermined position. The table 20 holds the objective printed circuit board 90 in a substantially horizontal position in the film detection apparatus 1 according to the first preferred embodiment.

The illumination system 21 includes an illumination light source 22, a half mirror 23, and a lens system (a condenser lens, an objective lens and the like) not shown. The illumination light source 22 in the first preferred embodiment may include, for example, an LED and a white fluorescent lamp, and is a light source for emitting so-called white light (a mixture of different wavelengths of light). The white light emitted from the illumination light source 22 is reflected from the half mirror 23 in a direction substantially perpendicular to the surface of the objective printed circuit board 90. Because the illumination system 21 directs the white light toward the objective printed circuit board 90, illuminating light for illuminating the film detection apparatus 1 in the first preferred embodiment is white light. Although not shown in FIG. 1, the illumination light source 22 is connected through a control signal cable and the like to the computer 10. The ON/OFF switching of the illumination light source 22 is performed under the control of the computer 10.

The illuminating light directed from the illumination system 21 is reflected from the surface of the objective printed circuit board 90 (more specifically, including the surface of the bonding pattern and the surface of the organic film) to pass through the half mirror 23 into the two-dimensional CCD camera 30. As shown in FIG. 1, since the table 20 holds the objective printed circuit board 90 so that the upper surface of the objective printed circuit board 90 extends in a direction substantially perpendicular to the direction of incidence of the illuminating light, a direction in which the illuminating light is specularly reflected is substantially perpendicular to the surface of the objective printed circuit board 90.

The two-dimensional CCD camera 30 is a typical digital camera for capturing a color image, and contains a structure (an image capturing part) having a two-dimensional array of photodetectors for detecting light components with wavelengths for R (red), G (green) and B (blue). Each of the photodetectors outputs an output value responsive to the amount of detected light (incident light) to the image processing board 16.

The two-dimensional CCD camera 30 according to the first preferred embodiment is placed in the optical path of the specular reflection of the illuminating light. The light incident on the two-dimensional CCD camera 30 is the illuminating light that is specularly reflected as described above.

The specularly reflected light is part of the reflected illuminating light which is large in amounts. Thus, the use of the specularly reflected illuminating light as the incident light on (imaging light for) the two-dimensional CCD camera 30 allows the capture of a relatively sharp image. The film detection apparatus 1 can therefore provide an easy-to-view image to the operator who makes a visual check.

The imaging region of the two-dimensional CCD camera 30 according to the first preferred embodiment is defined to include the entire upper surface of the objective printed circuit board 90 held by the table 20 by moving the table 20 and the two-dimensional CCD camera 30 relative to each other. In other words, the two-dimensional CCD camera 30 is capable of imaging a relatively large region (several square millimeters to tens of square millimeters) on the objective printed circuit board 90 at a time, and the film detection apparatus 1 is capable of measuring (inspecting) a plurality of spots within the region at a time. This achieves faster measurement than the process of measuring the plurality of spots one by one.

The functions and construction of the film detection apparatus 1 according to the first preferred embodiment are described above. Next, the operation of the film detection apparatus 1 will be described.

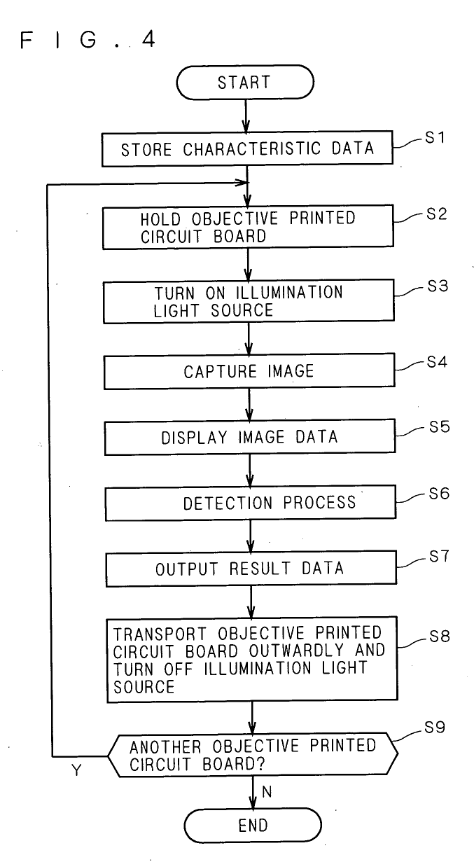

FIG. 4 is a flow chart showing the operation of the film detection apparatus 1 according to the first preferred embodiment. The operation of the film detection apparatus 1 to be described below is implemented by the computer 10 causing the CPU 11 to execute the program 123, unless otherwise specified.

First, the operator manipulates the manipulation part 14 of the film detection apparatus 1 to input information on which the characteristic data 100 is based to the film detection apparatus 1. In response to the input, the data processing part 110 generates the characteristic data 100 to transfer the characteristic data 100 to the fixed disk 122. The fixed disk 122 stores therein the characteristic data 100 transferred thereto (in Step S1).

A database for the characteristic data 100 is created in the fixed disk 122 by the execution of Step S1. The process of creating the database for the characteristic data 100 may be performed separately from the inspection process. In other words, the processes in Step S2 and its subsequent steps need not always be performed after Step S1. Once the database is created, the film detection apparatus 1 need not perform Step S1 each time the film detection apparatus 1 starts up, but may skip Step S1 to start at Step S2.

Next, the operation of the film detection apparatus 1 inspecting individual printed circuit boards will be described. The film detection apparatus 1 is on standby, with initialization thereof not shown completed, before an objective printed circuit board 90 is transported to the film detection apparatus 1. When an objective printed circuit board 90 to be inspected is transported to the film detection apparatus 1, the table 20 holds the objective printed circuit board 90 in a predetermined position (in Step S2). The illumination system 21 turns on the illumination light source 22 to direct the illuminating light onto the objective printed circuit board 90 held by the table 20 (in Step S3). Thus, the process of illuminating the objective printed circuit board 90 (or an illuminating process step) starts in Step S3 and continues until the illumination light source 22 is turned off in Step S8 to be described later.

When the illuminating process step starts in Step S3, the two-dimensional CCD camera 30 captures an image of the objective printed circuit board 90 irradiated with the illuminating light (in Step S4). Thus, the image processing board 16 generates the image data 102 based on a signal from the two-dimensional CCD camera 30.

The image data 102 generated by the image processing board 16 is displayed by the display 13 (in Step S5). This enables the operator to view a bonding pad of a bonding pattern of the objective printed circuit board 90 on the screen of the display 13. That is, the film detection apparatus 1 enables the operator to visually check whether an organic film is formed on the bonding pad or not on the screen of the display 13. Because the two-dimensional CCD camera 30 according to the first preferred embodiment captures a color image, the film detection apparatus 1 can display an image close to the real image of the objective printed circuit board 90 on the screen of the display 13. Additionally, the film detection apparatus 1 can display a sharp image because the two-dimensional CCD camera 30 uses the specularly reflected illuminating light emitted from the illumination light source 22 to capture the image.

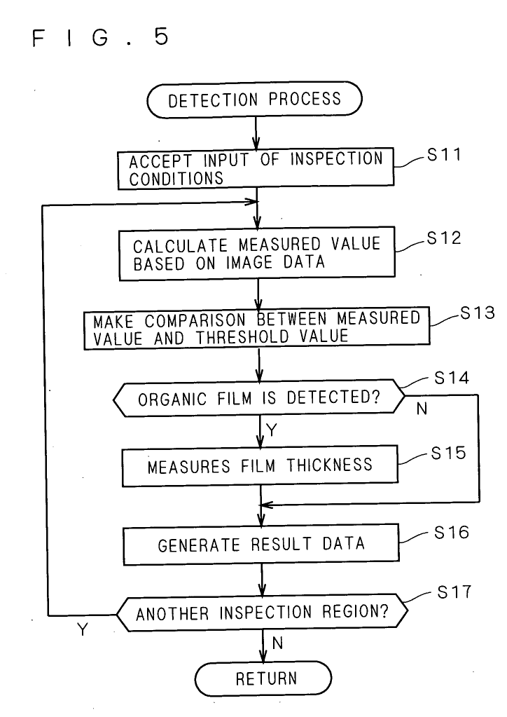

Next, the film detection apparatus 1 executes a detection process (in Step S6). FIG. 5 is a flow chart showing the details of the detection process in the film detection apparatus 1 according to the first preferred embodiment.

In the detection process, the film detection apparatus 1 accepts inspection conditions based on an input of the operator (in Step S11). The term “inspection conditions” used herein means information about which region of the objective printed circuit board 90 is to be inspected, about the type of the organic film to be detected, about the type of the objective printed circuit board 90, and the like. After the operator inputs the inspection conditions, the data processing part 110 identifies the inspection region on the objective printed circuit board 90 to generate the inspection region data 101, and acquires the characteristic data 100 suitable thereto from the fixed disk 122.

The identification of the inspection region in the first preferred embodiment is carried out by reading the position of a bonding pad from CAD data about the objective printed circuit board 90. Alternatively, the operator may manipulate the keyboard 140 to input the coordinates of the bonding pad, thereby pinpointing the inspection region. The inspection region need not always coincide with a region in which the bonding pad is formed. Thus, the operator may manipulate the mouse 141 to pinpoint any region while viewing the image data 102 displayed by the display 13.

In the process to be described below, the film detection apparatus 1 according to the first preferred embodiment detects and measures the organic film based on the captured image data 102. It is therefore very easy to identify the inspection region (a spot diameter or position) because the operator is required only to select a predetermined pixel contained in the image data 102.

In response to a keyword inputted by the operator, the data processing part 110 searches the database created in the fixed disk 122 to read out the characteristic data 100 to the RAM 121 in Step S111. The term “keyword” used herein means information about the type of the objective printed circuit board 90, about the type of the bonding pad, about the type of the organic film to be detected, and the like. The keyword is the information required to determine the inspection conditions for each of the individual objective printed circuit boards 90.

The characteristic data 100 according to the first preferred embodiment will be described. FIG. 6 shows a reflection characteristic obtained when white light is directed onto an organic film S formed on a pattern region. The ordinate in FIG. 6 represents the amount of light, and the abscissa represents the wavelength of light. Curves SP1 to SP4 in FIG. 6 are for printed circuit boards formed with the organic films S having thicknesses of 118 nm, 222 nm, 312 nm and 434 nm, respectively, on the pattern region. These printed circuit boards as samples are substantially identical in parameters (conditions) other then the film thickness with each other.

If an organic film S is present in the inspection region, the amount of specularly reflected light is changed by the light reflection characteristic of the organic film S. The samples formed with the organic films having increasing thicknesses shown in FIG. 6 exhibit the increasing amounts of reflected light. In particular, the organic films S show that a remarkable correlation between the film thickness and the amount of specularly reflected light is found for light of a short wavelength range.

A color image is composed of pixels each having a pixel value (designated hereinafter by the reference character R) corresponding to a red light component, a pixel value (designated hereinafter by the reference character G) corresponding to a green light component, and a pixel value (designated hereinafter by the reference character B) corresponding to a blue light component. It is apparent from FIG. 6 that the organic film S has the property of reflecting the blue light component well. To detect the organic film S, it is therefore preferable to use the pixel value B for judgment.

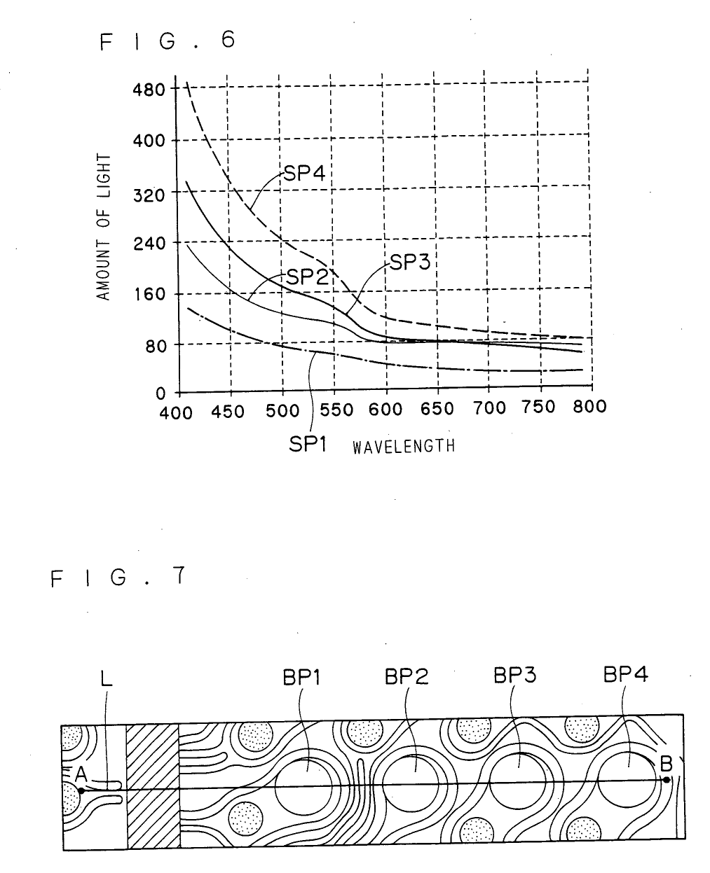

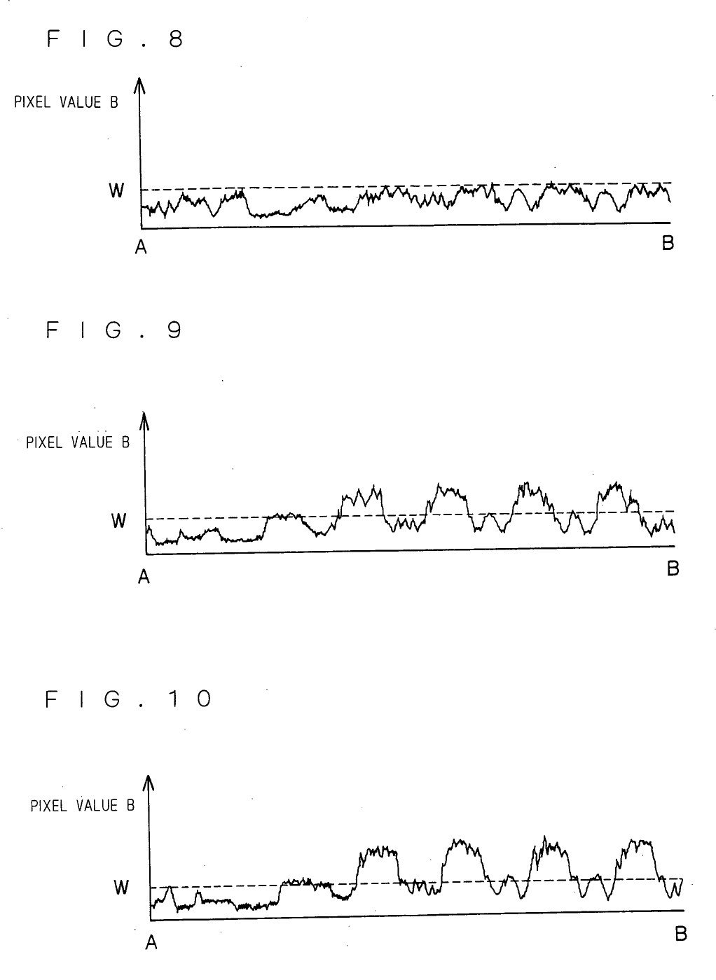

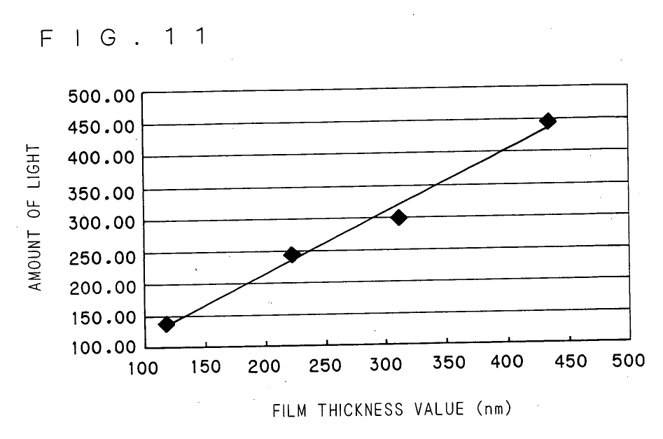

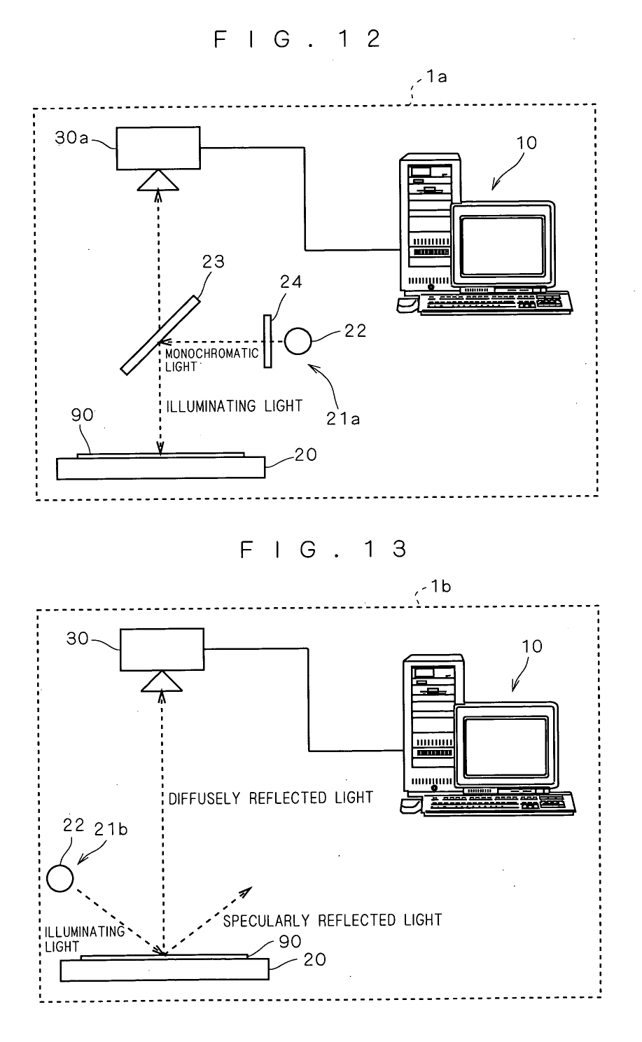

FIG. 7 shows examples of the bonding pads formed on a printed circuit board. The pads BP1 to BP4 shown in FIG. 7 are bonding pads made of copper. FIGS. 8 through 10 show the pixel value B obtained when the two-dimensional CCD camera 30 captures the images of the bonding pads shown in FIG. 7. FIG. 8 shows the pixel value B obtained when no organic film S is formed, and FIG. 9 shows the pixel value B obtained when the organic film S having a thickness of 0.2 μm is formed. FIG. 10 shows the pixel value B obtained when the organic film S having a thickness of 0.3 μm is formed. Only the pixel values B of pixels corresponding to the positions lying on the line L shown in FIG. 7 are plotted in order along the line L in FIGS. 8 through 10.

As shown in FIG. 8, the pixel value B barely exceeds the threshold value W when no organic film S is formed. As shown in FIGS. 9 and 10, on the other hand, the pixel value B of a pixel corresponding to the position where the organic film S is formed exceeds the threshold value W when the organic film S is formed on the bonding pads.

In other words, a small amount of blue light component is specularly reflected and the pixel value B is low in the position where no organic film S is formed. On the other hand, a large amount of blue light component is reflected and the pixel value B is high in the position where the organic film S is formed.

Thus, when a printed circuit board (acceptable board) formed with a suitable organic film S is previously imaged and the threshold value W is determined from the obtained pixel values B, whether the organic film S is present or absent in the inspection region of the objective printed circuit board 90 can be judged by comparing the pixel values B with the threshold value W.

Although the threshold value W is determined by averaging the pixel values B of the pixels obtained by capturing the image of the acceptable board in the first preferred embodiment, the pixel value B of, for example, a typical pixel may be used directly as the threshold value W. The film detection apparatus 1 according to the first preferred embodiment stores the threshold value W thus determined in Step S1.

Data about the threshold value W is inputted directly by the operator and stored in the film detection apparatus 1 according to the first preferred embodiment. Alternatively, the film detection apparatus 1 may cause the two-dimensional CCD camera 30 to sequentially capture the images of printed circuit boards used as samples under various conditions, analyze the obtained image data 102, and determines a suitable threshold value W from the pixel values to store the threshold value W. In this case, a common structure of the illumination system 21, the two-dimensional CCD camera 30 and the like may be used during an experiment for determination of the threshold value W and during the actual inspection. Thus, the conditions for the experiment and the conditions for the inspection are easily made identical with each other. This improves the precision of the inspection results.

The threshold value W takes on different suitable values depending on various conditions including the material and desired thickness of the organic film, the material of the printed circuit board, the distribution of the wavelength components of the illuminating light, the material and surface state of the bonding pads, and the like. Although the use of the pixel value B for the blue light component is effective to judge whether the organic film S is detected or not, the use of a pixel value for other than the blue light component (or pixel values for light of all wavelengths) is sometimes effective to judge whether another organic film composed of other materials is detected or not. Thus, the threshold value W for each of the various conditions is stored in Step S1 in the fixed disk 122 of the film detection apparatus 1. For the inspection in the film detection apparatus 1, the data processing part 110 searches the fixed disk 122 for a suitable threshold value W depending on these conditions to transfer the threshold value W as the characteristic data 100 onto the RAM 121.

The characteristic data 100 according to the first preferred embodiment contains information for measurement of the thickness of the organic film in addition to the information for judgment as to whether the organic film is present or absent, such as the above-mentioned threshold value W. FIG. 11 shows a relationship between the thickness value D of the organic film S and the amount of specularly reflected light of the short wavelength range. As shown in FIG. 11, the amount of specularly reflected light is approximately proportional to the thickness value D for the organic film S. Because the amount of specularly reflected light can be replaced with the pixel value B, a relationship between the film thickness value D and the pixel value B in the example shown in FIG. 11 can be approximated by
D=a×B+b (1)
where a and b are constants.

Thus, the film detection apparatus 1 replaces the relationship between the pixel value corresponding to a predetermined light component (the blue light component in the example shown in FIG. 11) obtained during the image capturing by means of the two-dimensional CCD camera 30 and the thickness value of the organic film, for example, with an approximation formula or the like to store the approximation formula as the characteristic data 100 in the fixed disk 122. Such an approximation formula can be determined by preparing printed circuit boards (sample boards) including the organic films having different known thickness values and measuring the amount of specularly reflected light for a predetermined light component from each of the sample boards as a pixel value.

The film detection apparatus 1 according to the first preferred embodiment handles, as the characteristic data 100 as appropriate, pieces of detection information (information for use in detection of the organic film such as the threshold value W) and measurement information (information for use in measurement of the thickness of the organic film such as the approximation formula) which are different from each other depending on various conditions including the materials of the printed circuit board an the organic film.

Referring again to FIG. 5, after the inspection conditions are inputted and the identification of the inspection region and the obtainment of the characteristic data 100 are completed, the detection part 111 determines the measured value based on the inspection region data 101 and the image data 102 (in Step S12). An example to be described below uses the pixel value B for the blue light component to detect the organic film S in the first preferred embodiment.

The process in Step S12 will be described in detail. The detection part 111 references the inspection region data 101 to select pixels contained in the inspection region among the pixels constituting the image data 102. Next, the detection part 111 adds the pixel values B of the selected pixels together, and divides the sum by the number of selected pixels, thereby to define the average as the measured value. Thus averaging the plurality of pixel values B in the inspection region reduces errors. However, the pixel value B of a single pixel may be used as the measure value.

As described above, the film detection apparatus 1 according to the first preferred embodiment calculates the measured value based on only the pixel value (the pixel value B) corresponding to the light component of a predetermined wavelength among the pixel values (the pixel values R, G and B) of the color image. This reduces the amount of computation as compared with the computation of the measured value based on all of the pixel values, to shorten the time required for the inspection. In this case, the determination as to which pixel value (in this preferred embodiment, the pixel value B) is to be used in accordance with the characteristics of the organic film improves the precision of the inspection.

After the measured value is determined, the detection part 111 makes a comparison between the measured value and the threshold value W (in Step S13), and then judges whether the organic film S is detected or not in accordance with the result of the comparison (in Step S14). If the measured value is greater than the threshold value W, it is judged herein that the organic film S is detected (Yes in Step S14). If the measured value is not greater than the threshold value W, it is judged that no organic film S is detected (No in Step S14).

If the organic film S is detected, the detection part 111 measures the thickness of the detected organic film S (in Step S15). Specifically, the detection part 111 substitutes the measured value for the pixel value B in the approximation formula (1) included in the characteristic data 100 to determine the thickness value D.

As described above, the film detection apparatus 1 according to the first preferred embodiment is capable of easily determining the thickness of the organic film because the relationship between the thickness of the organic film and the pixel value (the value determined depending on the amount of specularly reflected light) is previously stored as the characteristic data 100.

The image captured by the two-dimensional CCD camera 30 is such that the amount of light obtained when the illuminating light impinges on and is reflected from a subject (the objective printed circuit board 90) is recorded for a predetermined region (a two-dimensional region known as a so-called imaging region). The output values from the photodetectors (the pixel values in the image data 102) are determined depending on the amount of the reflected light. Thus, the film detection apparatus 1 according to the first preferred embodiment makes the inspection, with attention focused on the reflectance of the objective printed circuit board 90 varying depending on the state (the presence/absence and thickness) of the organic film. In other words, the process used herein may be said to be approximate in principle to a technique of emitting laser light to measure the reflected light.

An optical system for emitting laser light for measurement, however, is more costly than the construction using the illumination system 21 for emitting white light and the two-dimensional CCD camera 30. Additionally, the laser light has the drawbacks of having a high light intensity to possibly damage the organic film and of finding difficulties in setting the spot diameter (corresponding to the inspection region) at any value. In this respect, the film detection apparatus 1 including the two-dimensional CCD camera 30 is very excellent because the film detection apparatus 1 does not damage the organic film but can freely set the inspection region.

The inspection accuracy of the film detection apparatus 1 is lower than that of an inspection apparatus employing laser light. However, the organic film on the printed circuit board, which is intended to prevent the oxidation of the bonding pads, is not required to has as high a degree of accuracy of film thickness control as, for example, a resist film formed on a semiconductor substrate. In some cases, the film detection apparatus 1 may only detect whether the organic film is present or absent. Therefore, the inspection accuracy of the film detection apparatus 1 according to the first preferred embodiment can sufficiently meet the requirement in the art.

After the completion of the inspection, the film detection apparatus 1 generates the result data 103 in accordance with the inspection result to store the inspection result for the inspection region (in Step S16). In other words, the presence or absence of the organic film S in the inspection region, and the thickness value of the organic film S, if detected, are included in the result data 103.

After the inspection result about the single inspection region is stored, a judgment is made as to whether there is a yet-to-be-inspected inspection region or not (in Step S17). If there is a yet-to-be-inspected inspection region among the inspection regions identified in Step S11, the processing returns to Step S12 and is continued. If the inspection of all of the inspection regions is completed (or there is no yet-to-be-inspected inspection region), the detection process is terminated and the processing returns to the process of FIG. 4.

After the completion of the detection process in Step S6, the film detection apparatus 1 outputs and displays the inspection result for the at least one inspection region on the display 13 while referencing the result data 103 (in Step S7). The film detection apparatus 1 according to the first preferred embodiment displays the inspection result for the at least one inspection region by superimposing a checkmark on a portion corresponding to the inspection region of the image of the objective printed circuit board displayed in Step S5. A technique for outputting the inspection result is not limited to this.

This enables the operator to easily check whether the organic film S is formed in the at least one inspection region of the objective printed circuit board 90 or not.

If the organic film S is detected, the film detection apparatus 1 also displays the thickness of the detected organic film S. This enables the operator to more precisely judge whether the objective printed circuit board 90 is defective or not, and also allows a high level of product management including, for example, the feedback control of the step of forming the organic films in accordance with the measured thickness of the organic film S.

After the completion of the judgment of acceptance by the operator, the objective printed circuit board 90 is transported out of the film detection apparatus 1, and the illumination light source 22 is turned off (in Step S8). A judgment is made as to whether there is another objective printed circuit board 90 or not (in Step S9). If there is another objective printed circuit board 90, the processing returns to Step S2 to repeat the steps. If there is no objective printed circuit board 90 to be inspected, the processing is terminated.

As described above, the film detection apparatus 1 according to the first preferred embodiment is capable of previously storing the characteristic data 100 determined by the experiment in the fixed disk 122, causing the two-dimensional CCD camera 30 to capture the image of the objective printed circuit board 90 irradiated with the illuminating light to acquire the two-dimensional image data 102, and detecting the organic film based on the image data 102 and the characteristic data 100. The film detection apparatus 1 can detect the organic film based on objective data to make the uniform and precise inspection. This reduces the operating burdens on the operator who is required only to observe the outputted detection result.

The detection part 111 calculates the measured value inherent in the objective printed circuit board 90 based on the pixel value of the predetermined pixel in the image data 102, compares the measured value with the threshold value W contained in the characteristic data 100, and detects the organic film in accordance with the result of the comparison. This achieves the high-speed and easy inspection of the objective printed circuit board 90.

The detection part 111 can precisely and easily judge whether the organic film is present or absent by detecting the organic film based on only the pixel value corresponding to the light component of the predetermined wavelength, for example by selecting the light component having a wavelength which exhibits a large change rate in the amount of light incident on the image capturing element depending on the presence or absence of the organic film. Additionally, the reduction in the amount of computation achieves the high-speed inspection.

The detection part 111 detects the organic film based on only the pixel values of the pixels corresponding to the specified inspection region among the pixels contained in the image data 102, whereby the operator can specify any inspection region to make the inspection. This achieves the flexible and precise inspection of the bonding pads of any shape and of any size without being influenced by the covering situation of portions other than the bonding pads. Thus, a printed circuit board formed with an uneven organic film thereon may be easily subjected to the inspection.

The detection part 111 measures the thickness of the detected organic film S in accordance with the measure value, thereby to effect, for example, the feedback control of the step of forming the organic film in accordance with the measured thickness. In this manner, the detection part 111 can flexibly respond to the inspection result, as compared with the technique of detecting only the presence or absence of the organic film.

The provision of the display 13 for displaying the image data 102 captured by the two-dimensional CCD camera 30 enables the operator to visually check the image data 102.

The illumination system 21 directs the white light as the illuminating light onto the objective printed circuit board 90, and the two-dimensional CCD camera 30 acquires the color image as the image data 102, whereby a simple structure may be used for the illumination light source 22. Additionally, the image data 102 close to an actual image can be acquired. This enables the operator to precisely judge the state of the organic films, for example, when the operator observes the image data 102.

The two-dimensional CCD camera 30 is placed in the optical path of the specular reflection of the illuminating light directed from the illumination system 21. Thus, a relatively large amount of light is incident on the two-dimensional CCD camera 30 during the image capturing. This provides the sharp image data 102.

In the above-mentioned film detection apparatus 1 according to the first preferred embodiment, the illuminating light directed onto the objective printed circuit board 90 during the image capturing of the two-dimensional CCD camera 30 is the white light. The illuminating light, however, is not limited to the white light.

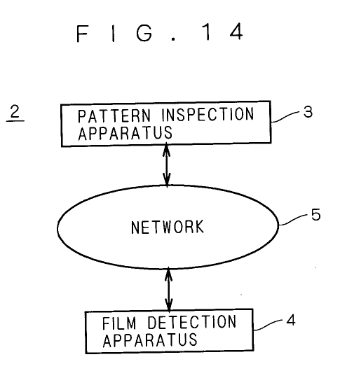

FIG. 12 shows the construction of a film detection apparatus 1a according to a second preferred embodiment of the present invention based on such a principle. The film detection apparatus 1a according to the second preferred embodiment is substantially similar in construction to the film detection apparatus 1 according to the first preferred embodiment except that an illumination system 21a includes a color filter 24 and that a two-dimensional CCD camera 30a is a device for capturing a monochrome image. The constituents of the film detection apparatus 1a of the second preferred embodiment similar in structure and function to those of the film detection apparatus 1 of the first preferred embodiment are designated as appropriate by like reference numerals and characters and will not be described.

The color filter 24 of the illumination system 21a is a filter which allows only the blue light component to pass through. Thus, only the blue light component of the white light emitted from the illumination light source 22 passes through the color filter 24 onto the objective printed circuit board 90. In other words, the illuminating light used when the two-dimensional CCD camera 30a captures the image of the objective printed circuit board 90 is blue light (or monochromatic light).

The two-dimensional CCD camera 30a does not include the RGB-capable photodetectors, but captures the monochrome image as the image data 102. Because the objective printed circuit board 90 is irradiated with the monochromatic light composed of the blue light component, the pixel value of each of the pixels of the image data 102 is a value depending on the amount of specularly reflected blue light, and corresponds to the pixel value B (the pixel value for the blue light component) of each of the pixels constituting the image data 102 of the first preferred embodiment.

Thus, treating the pixel value of each of the pixels of the image data 102 of the second preferred embodiment as the pixel value B of each of the pixels of the image data 102 of the first preferred embodiment allows the detection of the organic film S and the measurement of the thickness of the organic film S in a process similar to that of the first preferred embodiment to be described below.

As described above, the film detection apparatus 1a according to the second preferred embodiment produces effects similar to those of the film detection apparatus 1 according to the first preferred embodiment.

The illumination system 21a directs the monochromatic light as the illuminating light onto the objective printed circuit board 90. Thus, the film detection apparatus 1a can make an inspection similar to that of the film detection apparatus 1 of the first preferred embodiment by the use of the two-dimensional CCD camera 30a capable of capturing only monochrome images. This provides the film detection apparatus 1a at low cost.

The technique for producing the monochromatic light as the illuminating light of the illumination system 21a is not limited to the technique employing the color filter 24. For example, a monochromatic light source may be used as the illumination light source 22. In this case, it is not necessary to provide the color filter 24.

The film detection apparatus 1a may include a plurality of color filters 24 which allow light components of respective different wavelengths to pass through. In this case, the plurality of color filters 24 are appropriately selectively used depending on, for example, the characteristic of the organic film to be detected and the like, thereby to change the wavelength of the illuminating light which is the monochromatic light. This flexibly responds to an organic film to be detected using monochromatic light other than the blue light.

The two-dimensional CCD cameras 30 and 30a in the film detection apparatuses 1 and 1a of the above-mentioned preferred embodiments are placed in the optical path of the specular reflection of the illuminating light. An image capturing element for detecting the organic film need not always be placed in the optical path of the specularly reflected light.

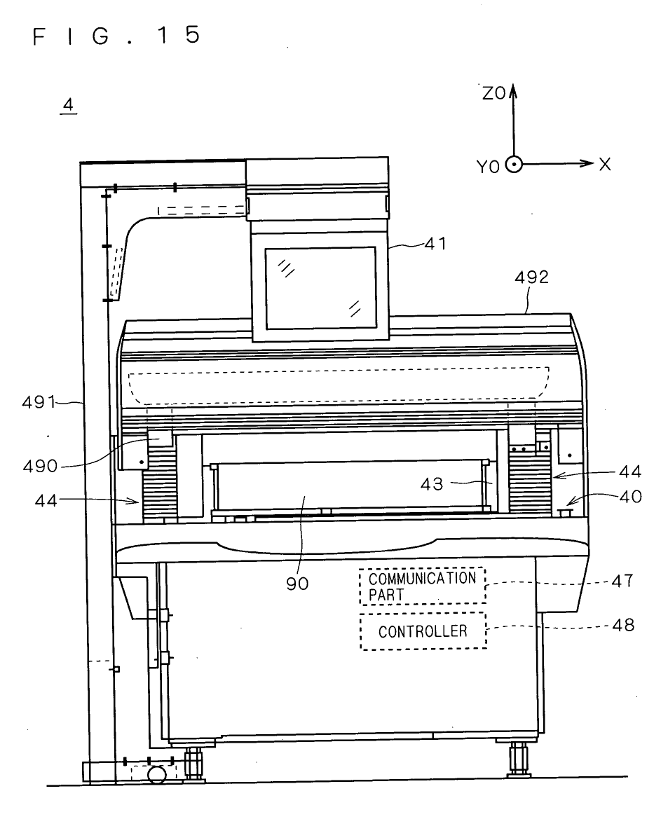

FIG. 13 shows the construction of a film detection apparatus 1b according to a third preferred embodiment of the present invention based on such a principle. The film detection apparatus 1b according to the third preferred embodiment is substantially similar in construction to the film detection apparatus 1 according to the first preferred embodiment except that an illumination system 21b does not include a structure corresponding to the half mirror 23. The constituents of the film detection apparatus 1b of the third preferred embodiment similar in structure and function to those of the film detection apparatus 1 of the first preferred embodiment are designated as appropriate by like reference numerals and characters and will not be described.

As illustrated in FIG. 13, the illumination system 21b directs white light produced by the illumination light source 22 in an oblique direction onto the surface of the objective printed circuit board 90. That is, the illumination system 21b is structured to obliquely directs the white light onto the objective printed circuit board 90.

In this case, the specularly reflected illuminating light travels in the direction shown in FIG. 13 and is not incident on the two-dimensional CCD camera 30. In other words, the two-dimensional CCD camera 30 of the third preferred embodiment is positioned off the optical path of the specular reflection of the illuminating light, and the incident light on the two-dimensional CCD camera 30 is diffusely reflected illuminating light.

Because the organic film S on the objective printed circuit board 90 has a relatively flat surface, the illuminating light impinging upon the organic film S is principally specularly reflected, and very little of the specularly reflected light enters the two-dimensional CCD camera 30. The light passing through the organic film S onto a bonding pad is diffusely reflected because of the rough surface of the bonding pad, and part of the diffusely reflected light travels toward the two-dimensional CCD camera 30. However, a small amount of light passing through the organic film S results in a small amount of light incident on the two-dimensional CCD camera 30. Therefore, an image portion where the organic film S is present provides relatively low pixel values of the pixels constituting the image data 102 to become a dark image portion.

In an image portion where the organic film S is not formed, the illuminating light impinges directly on the bonding pad. Thus, a relatively large part of light is diffusely reflected, and the diffusely reflected light travels toward the two-dimensional CCD camera 30. Therefore, the image portion where the organic film S is absent provides relatively high pixel values of the pixels constituting the image data 102 to become an image portion of a bright bonding pad. If the bonding pads are made of copper, the red light component of the illuminating light is well reflected from the bonding pads. The film detection apparatus 1b of the third preferred embodiment accordingly detects the organic film S based on the pixel values (the pixel values R) for the red light component of the pixels constituting the image data 102.

The operation of the film detection apparatus 1b of the third preferred embodiment is substantially similar to that of the film detection apparatus 1 of the first preferred embodiment, and will not be described in detail. In a step similar to Step S113, a comparison is made between the measured value obtained from the image data 102 and the threshold value W. A judgment in a step corresponding to Step S14 is as follows. If the result of the comparison indicates that the measured value is less than the threshold value W, it is judged that the organic film S is detected. If the result of the comparison indicates that the measured value is not less than the threshold value W, it is judged that the organic film S is not detected.

The amount of light passing through the organic film S and diffusely reflected from the bonding pad is influenced by the thickness of the organic film S. Therefore, the film detection apparatus 1b can also measure the thickness of the organic film S when the relationship between the thickness value of the organic film S and the pixel value is previously determined as the characteristic data 100 as in the first preferred embodiment.

As described above, the film detection apparatus 1b according to the third preferred embodiment is capable of detecting the organic film S in a manner similar to the film detection apparatuses 1 and 1a of the first and second preferred embodiments.

The property such that the amount of diffusely reflected red light is decreased in the presence of the organic film S and is increased in the absence of the organic film S is considered to stem mainly from the fact that the organic film S has a flat surface, and is slightly influenced by the material of the organic film S. Thus, positioning the two-dimensional CCD camera 30 off the optical path of the specular reflection of the illuminating light directed from the illumination system 21b reduces the dependence of the film detection apparatus 1b on the material of the organic film S. The material of the bonding pads is determined as copper in the art according to the present invention. This consequently reduces the dependence of the inspection result in the film detection apparatus 1b on the material to improve flexibility.

In the above-mentioned preferred embodiments, the operator inputs information about the position, shape and size of the inspection region in the detection process of Step S6 (in Step S11). A technique for obtaining such information is not limited to the input of the operator.

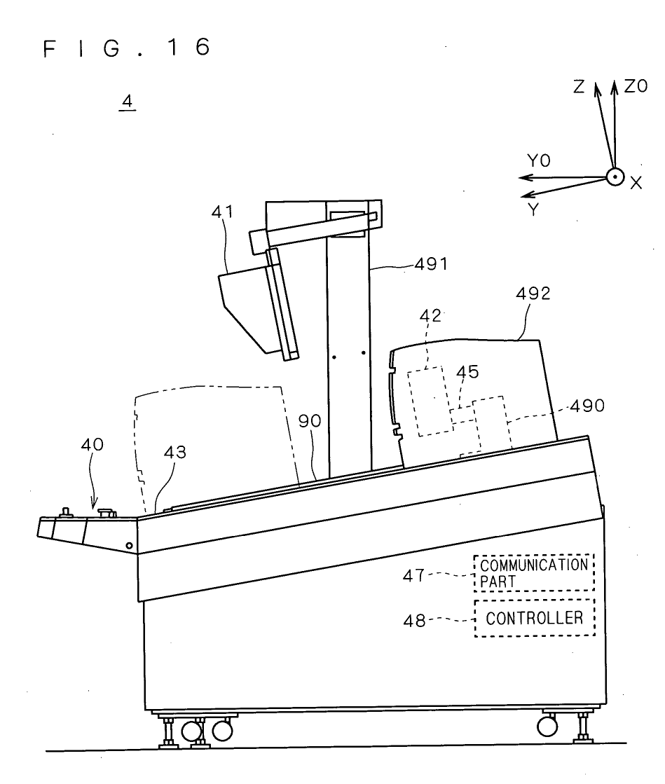

FIG. 14 is a diagram showing the construction of an inspection system 2 according to a fourth preferred embodiment of the present invention based on such a principle. The inspection system 2 includes a pattern inspection apparatus 3, and a film detection apparatus 4 for detecting the organic film formed on the bonding pattern. The inspection system 2 is constructed such that the pattern inspection apparatus 3 and the film detection apparatus 4 are connected to each other through a network 5.

The network 5 may be any network capable of carrying out data communications between the pattern inspection apparatus 3 and the film detection apparatus 4 by using a predetermined communication protocol, such as LAN (Local Area Network) and a public network. A plurality of pattern inspection apparatuses 3 and a plurality of film detection apparatuses 4 may be connected to the network 5. An apparatus other than the pattern inspection apparatus 3 and the film detection apparatus 4 may be connected to the network 5. For example, a server apparatus for integrated management of these apparatuses, a printing apparatus for outputting data as appropriate, and a defect identifying apparatus for identifying a detected defect may be connected to the network 5.

The pattern inspection apparatus 3 is an apparatus which captures the image of the surface of the objective printed circuit board 90 to acquire image data, performs image processing such as edge detection and pattern recognition on the image data, and detects the bonding pads formed on the objective printed circuit board 90.

The pattern inspection apparatus 3 adds ID information for identification of the objective printed circuit board 90 to information about the shape and size of such a detected bonding pad and about the position thereof on the objective printed circuit board 90, thereby to generate inspection region data 400. Thus, the pattern inspection apparatus 3 has the function of reading information, which has been inputted by the operator in the film detection apparatuses 1, 1a and 1b of the above-mentioned preferred embodiments, from the objective printed circuit board 90.

The pattern inspection apparatus 3 transmits the generated inspection region data 400 through the network 5 to the film detection apparatus 4.

A pattern inspection apparatus having conventionally been proposed has the function of detecting a pattern to make a comparison between the detected pattern and a reference pattern including a CAD data pattern and an acceptable board pattern, thereby detecting a defect in the detected pattern. It is, however, sufficient for the pattern inspection apparatus 3 of the inspection system 2 according to the fourth preferred embodiment to have the function of automatically obtaining information about the position, shape and size of a bonding pad of the bonding pattern on the objective printed circuit board 90 to transmit the information as the inspection region data 400 to the film detection apparatus 4. The pattern inspection apparatus 3 may have the function of detecting a defect.

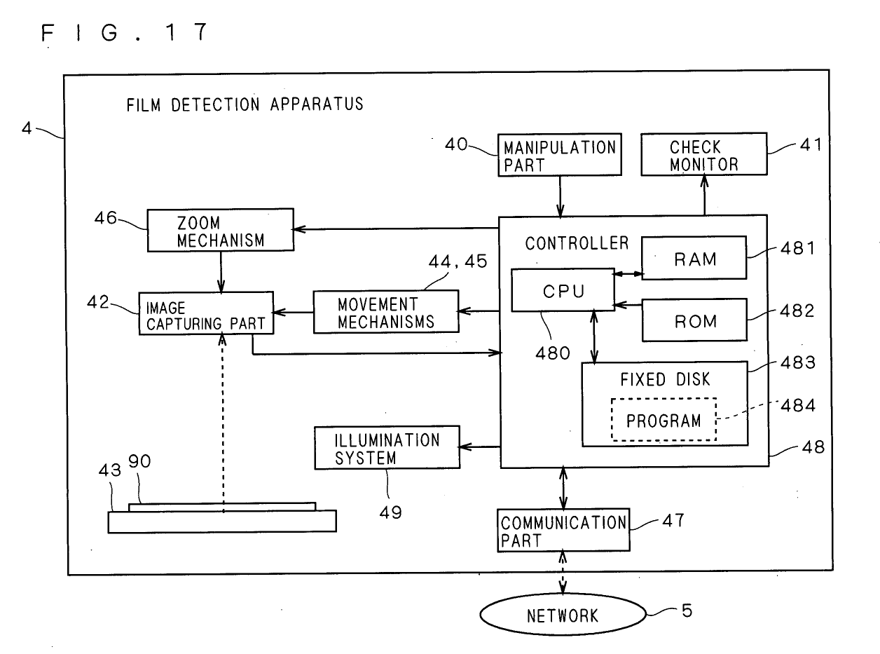

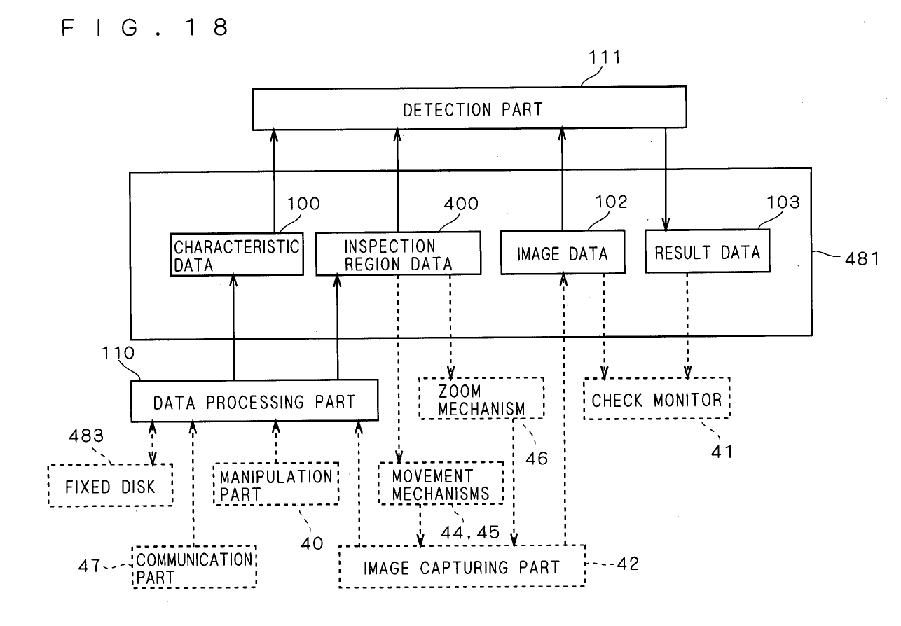

FIG. 15 is a front view of the film detection apparatus 4, and FIG. 16 is a side view of the film detection apparatus 4. FIG. 17 is a block diagram showing the construction of the film detection apparatus 4. A horizontal X-axis, a Y0-axis and a vertical Z0-axis are defined in FIG. 15. Also defined in FIG. 16 are:
(1) a Y-axis slightly downwardly inclined with respect to the horizontal Y0-axis within a vertical plane and perpendicular to the X-axis, and
(2) a Z-axis perpendicular to the X-axis and the Y-axis.
   The Y-axis and the Z-axis may coincide with the Y0-axis and the Z0-axis, respectively, although inclined with respect to the Y0-axis and the Z0-axis in the fourth preferred embodiment.

The film detection apparatus 4 includes a manipulation part 40, a check monitor 41, an image capturing part 42, an inspection stage 43, a pair of movement mechanisms 44, a movement mechanism 45, a zoom mechanism 46, a communication part 47, and a controller 48. The film detection apparatus 4 further includes a support table 490 having a bridging structure extending substantially horizontally between opposite side portions of the inspection stage 43, a support member 491 for supporting the check monitor 41 over the film detection apparatus 4, and a protective cover 492 for protecting the image capturing part 42.

With such an arrangement, the film detection apparatus 4 functions as an apparatus for detecting an organic film formed on the bonding pads of a printed circuit board in a similar manner to the film detection apparatuses 1, 1a and 1b of the first, second and third preferred embodiments. In particular, description on constituents of the film detection apparatus 4 of the fourth preferred embodiment which are similar to those of the film detection apparatus 1 of the first preferred embodiment will be omitted as appropriate.

The manipulation part 40 is manipulated, for example, when an operator inputs an instruction to the film detection apparatus 4. That is, the manipulation part 40 is similar in function to the manipulation part 14. Specifically, the manipulation part 40 includes various buttons, a keyboard, a mouse and the like, but may include a trackball, a joy stick, a touch panel and the like.

The check monitor 41 is supported by the support member 491 over the film detection apparatus 4, and displays information required for manipulation of the film detection apparatus 4, the image data 102, and the result data 103 on a screen thereof, based on a control signal from the controller 48. The check monitor 41 is an element corresponding to the display 13, and includes, for example, a liquid crystal display.

The image capturing part 42 is an element corresponding to the two-dimensional CCD camera 30. The image capturing part 42 photoelectrically converts light incident thereon along an optical axis (an axis substantially perpendicular to the X-axis and the Y-axis) of an optical system such as a taking lens by means of an image reception device (CCD) contained therein to capture an image of the objective printed circuit board 90 (an object to be inspected) held by the inspection stage 43.

The image capturing part 42 transmits the image data 102 about the captured image of the objective printed circuit board 90 to the controller 48. The film detection apparatus 4 according to the fourth preferred embodiment does not have an element corresponding to the image processing board 16, but performs image processing by means of software. Of course, the film detection apparatus 4 may be adapted to generate the image data 102 by means of hardware corresponding to the image processing board 16.

The image capturing part 42 is also used for reading an identification number (ID information) printed in a predetermined position of the objective printed circuit board 90. The image-captured ID information is subjected to a character recognition process in the controller 48, and is used for the process of individually identifying the objective printed circuit board 90 held by the inspection stage 43. Unlike the two-dimensional CCD cameras 30 and 30a of the above-mentioned preferred embodiments, the image capturing part 42 of the fourth preferred embodiment does not have an imaging region large enough to capture the image of the entire surface of the objective printed circuit board 90 at a time. For image capturing of the entire surface of the objective printed circuit board 90, it is necessary to capture a plurality of images while moving the image capturing part 42 and the objective printed circuit board 90 relative to each other, the details of which will be described later.

The upper surface of the inspection stage 43 is substantially parallel to an X-Y plane. The objective printed circuit board 90 transferred to the film detection apparatus 4 by an operator or a transport mechanism not shown is held in a predetermined position of the upper surface of the inspection stage 43.

The pair of movement mechanisms 44 are mounted on opposite sides, respectively, of the support table 490, and move the support table 490 in a direction of the Y-axis. This enables the controller 48 to control the distance that the support table 490 moves and the position of the support table 490. The movement mechanism 45 is mounted to the support table 490, and moves the image capturing part 42 along the support table 490 in a direction of the X-axis. This enables the controller 48 to control the distance that the image capturing part 42 moves and the position of the image capturing part 42.

A known mechanism using a servo motor, a ball screw and a feed nut may be used as an example of the movement mechanisms 44 and 45 having such functions. Specifically, the servo motor rotates the ball screw extending in a predetermined direction to move the feed nut in the predetermined direction, and the controller 48 controls the angle of rotation of the servo motor to control the positions of the movement mechanisms 44 and 45. The movement mechanisms 44 and 45 are not limited to the above-mentioned mechanisms, but may be achieved by other known mechanisms.

Thus, the provision of the movement mechanisms 44 and 45 in the film detection apparatus 4 enables the film detection apparatus 4 to move the image capturing part 42 to any position relative to the objective printed circuit board 90 in the X-Y plane. As described above, the imaging region of the image capturing part 42 is not sized to capture the image of the entire objective printed circuit board 90 at a time. However, the image capturing part 42 is capable of capturing an image of any region (a region specified as the inspection region) of the objective printed circuit board 90 held by the inspection stage 43 while being moved by the movement mechanisms 44 and 45. Therefore, the film detection apparatus 4 can perform image capturing a plurality of times to capture the images of the entire objective printed circuit board 90 in a similar manner to the film detection apparatus 1 of the first preferred embodiment.

Although not shown in FIGS. 15 and 16, the zoom mechanism 46 has the function of determining the zoom position of the optical system of the image capturing part 42 based on a control signal from the controller 48 to determine the image magnification of the image capturing part 42. Thus, the image capturing part 42 can capture a magnified image of the objective printed circuit board 90. The film detection apparatus 4 is therefore capable of making a precise inspection.

The communication part 47 carries out data communication with the pattern inspection apparatus 3 through the network 5. Thus, the film detection apparatus 4 receives the inspection region data 400 transmitted from the pattern inspection apparatus 3.

The controller 48 is connected to other constituents of the film detection apparatus 4 in such a manner as to be able to transmit and receive signals to and from these constituents, and includes a CPU 480, a RAM 481, a ROM 482 and a fixed disk 483, which correspond to the CPU 11, the RAM 121, the ROM 120 and the fixed disk 122, respectively, of the first preferred embodiment. Thus, the film detection apparatus 4 also has a function as a typical computer. A program 484 is stored in the fixed disk 483.

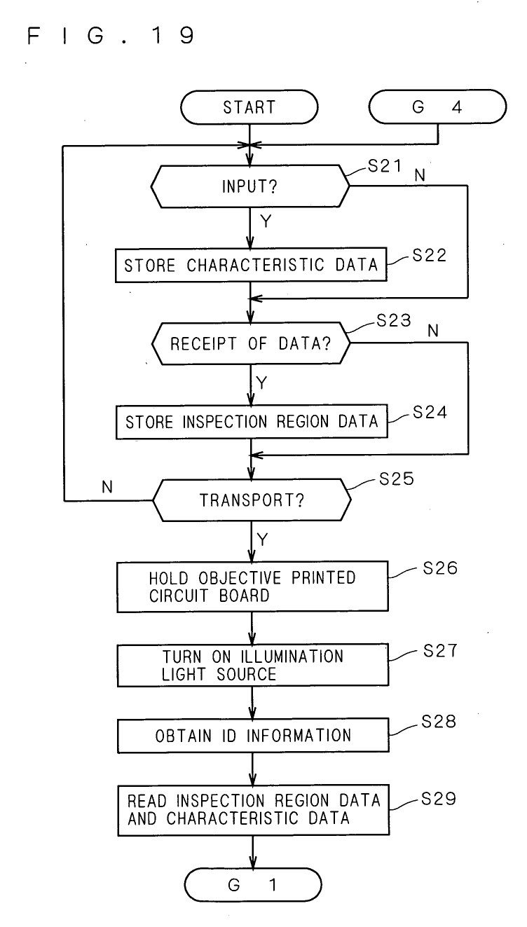

FIG. 18 is a block diagram showing functional elements of the controller 48 together with signal flows. The CPU 480 in the controller 48 operates in accordance with the program 484 to implement the data processing part 110 and the detection part 111 among the functional elements shown in FIG. 18.

The data processing part 110 generates the characteristic data 100 based on information inputted by the operator manipulating the manipulation part 40. The generated characteristic data 100 is stored in the fixed disk 483 in a searchable manner using the ID information and the like as a keyword. As in the film detection apparatus 1 of the first preferred embodiment, the data processing part 110 creates a database for the characteristic data 100 in the fixed disk 483.

When the communication part 47 receives the inspection region data 400 from the pattern inspection apparatus 3 through the network 5, the received inspection region data 400 is stored in the fixed disk 483.

The data processing part 110 also has the function of analyzing the ID information (printed on the objective printed circuit board 90) image-captured by the image capturing part 42 by a character recognition process to read out suitable portions of the characteristic data 100 and inspection region data 400 from the fixed disk 483 to the RAM 481 in response to the ID information.

Referring again to FIG. 17, an illumination system 49 includes the illumination light source 22 and the half mirror 23 similar to those of the illumination system 21 of the first preferred embodiment, although the details are not shown. Specifically, the illumination system 49 directs white light as the illuminating light onto the objective printed circuit board 90.

Referring again to FIGS. 15 and 16, the support table 490 includes the bridging structure extending substantially horizontally in a direction of the X-axis between opposite side portions of the inspection stage 43, and has the function of supporting the image capturing part 42 over the inspection stage 43. The above-mentioned movement mechanism 45 is mounted to the support table 490.

The protective cover 492 has not only the function of protecting the image capturing part 42 but also the function of preventing other light from entering the image capturing part 42 to enable the image capturing part 42 to capture a sharp image of the objective printed circuit board 90. The protective cover 492 is fixed to the support table 490. The protective cover 492 is moved in a direction of the Y-axis together with the support table 490 by the movement mechanisms 44 to cover the image capturing part 42 from above at all times.

The construction and function of the inspection system 2 are described above. Next, the operation of the inspection system 2 according to the fourth preferred embodiment will be described.

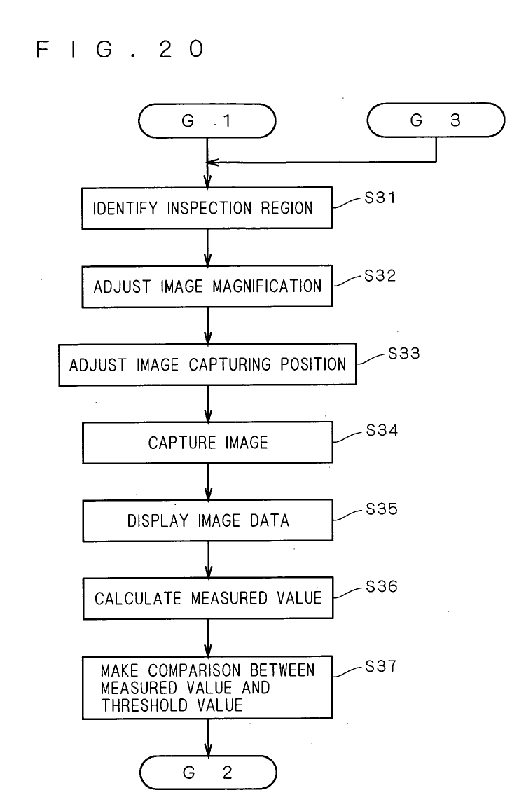

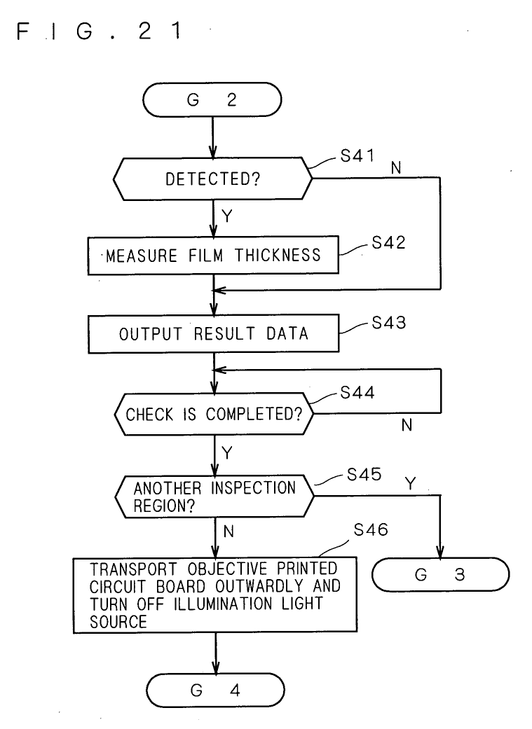

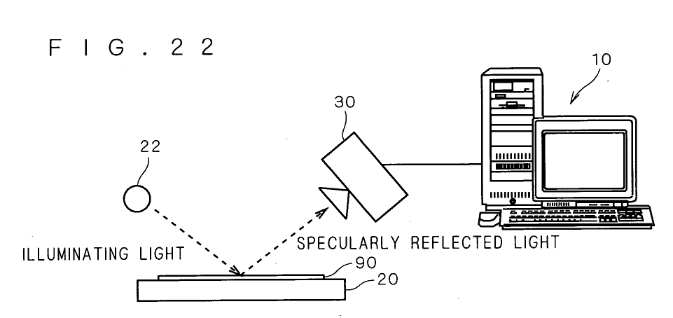

FIGS. 19 through 21 are flow charts principally showing process steps related to the film detection apparatus 4 in the operation of the inspection system 2 according to the fourth preferred embodiment.

In the inspection system 2, the pattern inspection apparatus 3 detects a bonding pad of a bonding pattern on the objective printed circuit board 90 as described above before the film detection apparatus 4 detects the organic film. The pattern inspection apparatus 3 generates the inspection region data 400 for the detected bonding pad.

The film detection apparatus 4 is on standby while monitoring an input by the operator (in Step S21), the receipt of data from the pattern inspection apparatus 3 (in Step S23) and the transport of the objective printed circuit board 90 into the film detection apparatus 4 (in Step S25).

When there is an input by the operator (Yes in Step S21), the data processing part 110 generates the characteristic data 100 based on the inputted information to store the characteristic data 100 in the fixed disk 483 (in Step S22).

When the communication part 47 receives data from the pattern inspection apparatus 3 (Yes in Step S23), the data processing part 110 stores the received inspection region data 400 in the fixed disk 483 (in Step S24).

When the objective printed circuit board 90 is transported into the film detection apparatus 4 (Yes in Step S25), the inspection stage 43 holds the objective printed circuit board 90 transported into the film detection apparatus 4 (in Step S26), and the film detection apparatus 4 starts the inspection.

When the inspection stage 43 holds the objective printed circuit board 90 in a predetermined position, the illumination system 49 turns on the illumination light source 22 (in Step S27). Thus, the white light is directed vertically downwardly onto the objective printed circuit board 90.

With the objective printed circuit board 90 illuminated by the illumination system 49, the image capturing part 42 captures the image of the ID information printed in a predetermined position of the objective printed circuit board 90, and the data processing part 110 obtains the ID information based on the captured image data (in Step S28). Using the obtained ID information as a keyword, the data processing part 110 reads the inspection region data 400 and the characteristic data 100 from the fixed disk 483 (in Step S29).

In the inspection system 2 according to the fourth preferred embodiment, the inspection of the objective printed circuit boards 90 is thus managed by the ID information assigned to each objective printed circuit board 90. In other words, once the objective printed circuit boards 90 are identified by the ID information, the characteristic data 100 suitable for each of the objective printed circuit boards 90 can be read from the fixed disk 483 without the need for the operator to input the inspection conditions as shown in Step S11 (FIG. 5) of the first preferred embodiment.

In the above-mentioned preferred embodiments, the input of the CAD data (or the input of the instruction by the operator) is required in Step S11 for the purpose of identifying the inspection region. The inspection system 2 according to the fourth preferred embodiment, however, effectively uses the information (inspection region data 400) about the position of the bonding pad and the like obtained by the pattern inspection apparatus 3 prior to the inspection process step of the film detection apparatus 4, thereby to reduce the burdens on the operator. Because the CAD data includes an ideal design pattern, a mismatch such as positional error can occur between the bonding pattern of the objective printed circuit board 90 actually produced and the CAD data pattern. Therefore, a more precise inspection is made by identifying the inspection region in accordance with the inspection region data 400 detected for each objective printed circuit board 90 as in the inspection system 2 of the fourth preferred embodiment.

After the reading of the inspection region data 400 and the characteristic data 100 is completed, the inspection region is identified by reference to the inspection region data 400 (in Step S31). Specifically, a plurality of regions should be inspected (or a plurality of inspection regions are present) because a plurality of bonding pads of the bonding pattern are formed on the objective printed circuit board 90. The controller 48 references the inspection region data 400 to select one of the plurality of bonding pads detected by the pattern inspection apparatus 3, thereby identifying the inspection region from the position, shape and size of the selected bonding pad.

After the inspection region is identified, the controller 48 determines the image magnification of the image capturing part 42 so that the identified inspection region is contained in the imaging region of the image capturing part 42, based on the shape and size of the inspection region. The controller 48 also controls the zoom mechanism 46 to adjust the image magnification of the image capturing part 42 (in Step S32). The controller 48 determines the image capturing position of the image capturing part 42 based on the position of the inspection region, and controls the movement mechanisms 44 and 45 to adjust the image capturing position of the image capturing part 42 (in Step S33).

After the image magnification and the image capturing position of the image capturing part 42 are determined, the image capturing part 42 captures the image of the objective printed circuit board 90 (in Step S34), and the check monitor 41 displays the image data 102 obtained by the image capturing (in Step S35).

Next, while referencing the inspection region data 400, the detection part 111 selects the pixels corresponding to the inspection region among the pixels constituting the image data 102 to calculate the measured value for the pixel values of the selected pixels (in Step S36). The technique of determining the measured value is similar to that of the above-mentioned preferred embodiments and will not be described.

While referencing the characteristic data 100, the detection part 111 makes a comparison between the measured value and the threshold value W (in Step S37), to detect the organic film S in accordance with the result of the comparison (in Step S41). If the organic film S is detected, the film thickness is determined from the approximation formula by reference to the characteristic data 100 (in Step S42). If the organic film S is not detected, Step S42 is skipped. The technique of determining the film thickness value is similar to that of the above-mentioned preferred embodiments, and will not be described.

After the detection of the organic film S and the measurement of the film thickness of the detected organic film S are completed, the detection part 111 generates the result data 103 based on the result of detection of the organic film S and the result of the measurement of the thickness of the detected organic film S. The controller 48 displays the result data 103 on the screen of the check monitor 41 (in Step S43).

This enables the operator to view the result data 103 displayed on the check monitor 41 to judge whether the inspection region is defective or not. After the check on the inspection region, the operator manipulates the manipulation part 40 to input an instruction so indicating to the film detection apparatus 4. The film detection apparatus 4 monitors the input of this instruction to wait until the completion of the checking operation of the operator (in Step S44).

Upon accepting the input of the instruction from the operator, the controller 48 references the inspection region data 400 to judge whether there is another yet-to-be-inspected inspection region or not (in Step S45). If there is another yet-to-be-inspected inspection region, the processing in Step S31 and its subsequent steps for the inspection region is repeated. If there is no yet-to-be-inspected inspection region, the objective printed circuit board 90 is carried out of the film detection apparatus 4, and the illumination light source 22 is turned off. Then, the processing returns to Step S21.

As described above, the inspection system 2 of the fourth preferred embodiment produces effects similar to those of the above-mentioned preferred embodiments.

Connecting the pattern inspection apparatus 3 and the film detection apparatus 4 to each other through the network 5 enables the film detection apparatus 4 to receive the inspection region data 400 from the pattern inspection apparatus 3 to detect the organic film in the region of the bonding pad detected by the pattern inspection apparatus 3. This eliminates the need for the input of the data for identifying the inspection region, thereby to reduce the burdens on the operator.

For purposes of discussion, the processes in Steps S21 through S25 are not executed while the objective printed circuit board 90 is transported into the film detection apparatus 4 in the above description. However, the process of storing the characteristic data 100 by the input of the operator (Steps S21 and S22) and the process of receiving and storing the inspection region data 400 (Steps S23 and S24) are actually allowed to be executed in parallel with the process of inspecting the objective printed circuit board 90.

The illumination system 49 in the film detection apparatus 4 may be an illumination system for directing monochromatic light in a similar manner to the illumination system 21a of the second preferred embodiment. The image capturing part 42 may be positioned off the optical path of the specular reflection of the illuminating light in a similar manner to the two-dimensional CCD camera 30a of the third preferred embodiment.

The film detection apparatus according to the above-mentioned preferred embodiments makes the direct comparison between the measured value and the threshold value W to detect the organic film in accordance with the result of the comparison. The technique of detecting the organic film is not limited to this. For example, the sum of the pixel values of the pixels contained in the inspection region may be used as the measured value and compared with the threshold value W multiplied by the number of pixels contained in the inspection region. In other words, the threshold value W included in the characteristic data 100 may be compared after some type of calculation is performed on the threshold value W.

The threshold value W is not limited to the pixel value obtained when the image of an acceptable printed circuit board is captured (or the value determined in accordance with the amount of specularly reflected light). For example, the organic film may be judged not to be detected if the film thickness value D obtained by substituting the measured value for the pixel value B in the approximation formula (1) is less than a predetermined value (which serves as the threshold value W in this case).

The comparison between the measured value and the threshold value W is illustrated as made for each inspection region in the above-mentioned preferred embodiments, but is not limited to this. The pixel value of each of the pixels in the inspection region may be used as the measured value and be compared with the threshold value W for each pixel. In this case, the organic film may be judged to be abnormal in this inspection region if the organic film is not detected for at least a predetermined number of adjacent pixels. The use of such a judging technique allows the precise detection of the absence of a defect of the organic film such as for example a pinhole-shaped defect to achieve a high-precision inspection.

The order of the processes to be executed is not limited to the order of the steps described in the above-mentioned preferred embodiments. For example, displaying the result of the inspection (in Step S7) in the first preferred embodiment need not be executed after the answer to the judgment in Step S17 is “Yes” and the inspection for all inspection regions is completed, but may be executed after the inspection for each of the inspection regions is completed. That is, the steps in the above-mentioned preferred embodiments may be executed in any order that produces similar effects.

The technique of placing the two-dimensional CCD camera 30 in the optical path of the specular reflection of the illuminating light is not limited to the arrangement (vertical downward illumination) shown in FIG. 1. FIG. 22 shows a technique for placing the two-dimensional CCD camera 30 in the optical path of the specular reflection of the illuminating light without using the vertical downward illumination technique. The arrangement shown in FIG. 22 allows the placement of the two-dimensional CCD camera 30 in the optical path of the specular reflection of the illuminating light to produce effects similar to those of the film detection apparatus 1 of the first preferred embodiment.

The film detection apparatus 1 is required only to capture an image to provide two-dimensional image data, and preferably uses a two-dimensional CCD. The film detection apparatus 1, however, may use a linear CCD for scanning a printed circuit board to capture the image thereof, thereby providing two-dimensional image data.

The film detection apparatus 1 may further include a microscope for magnifying a region of the objective printed circuit board 90 corresponding to the image data 102 obtained by the two-dimensional CCD camera 30. This enables the operator to directly observe the objective printed circuit board 90 for the judgment as to whether the objective printed circuit board 90 is defective or not.

While the invention has been described in detail, the foregoing description is in all aspects illustrative and not restrictive. It is understood that numerous other modifications and variations can be devised without departing from the scope of the invention.

What is claimed is:

1. A film detection apparatus for detecting an organic film formed on a printed circuit board formed with a pattern, said film detection apparatus comprising:
a storage element for previously storing characteristic information serving as a reference;
a holding element for holding an objective printed circuit board to be inspected;
an illumination element for directing illuminating light onto said objective printed circuit board held by said holding element;
an image capturing element for capturing an image of said objective printed circuit board irradiated with said illuminating light to provide two-dimensional image data;
a detection element for detecting said organic film based on said image data provided from said image capturing element and said characteristic information stored in said storage element; and
an output element for outputting a result of the detection of said detection element to an operator.

2. The film detection apparatus according to claim 1, wherein
said detection element compares pixel values of predetermined pixels included in said image data or a measured value calculated from said pixel values with a predetermined threshold value included in said characteristic information to detect said organic film in accordance with a result of the comparison.

3. The film detection apparatus according to claim 2, wherein
said detection element detects said organic film based on only a pixel value for light of a predetermined wavelength.

4. The film detection apparatus according to claim 2, further comprising
a specification element for specifying an inspection region of said objective printed circuit board,
wherein said image capturing element captures the image so that said inspection region specified by said specification element is included in said image data, and
wherein said detection element calculates the sum or the average of the pixel values of said predetermined pixels, said predetermined pixels being pixels corresponding to said inspection region among all pixels included in said image data.

5. The film detection apparatus according to claim 2, wherein
said detection element measures the thickness of the detected organic film in accordance with said pixel values or said measured value.

6. The film detection apparatus according to claim 1, further comprising
a display element for displaying said image data captured by said image capturing element.

7. The film detection apparatus according to claim 1, wherein
said illumination element directs monochromatic light as said illuminating light onto said objective printed circuit board.

8. The film detection apparatus according to claim 1, wherein
said illumination element directs white light as said illuminating light onto said objective printed circuit board, and
said image capturing element provides a color image as said image data.

9. The film detection apparatus according to claim 1, further comprising
a microscope for magnifying a region of said objective printed circuit board corresponding to said image data obtained by said image capturing element.

10. The film detection apparatus according to claim 1, wherein
said image capturing element is positioned in an optical path of specular reflection of said illuminating light directed by said illumination element.

11. The film detection apparatus according to claim 1, wherein
said image capturing element is positioned off an optical path of specular reflection of said illuminating light directed by said illumination element.

12. An inspection system for inspecting a printed circuit board, comprising:
(a) a pattern inspection apparatus for detecting a pattern formed on a printed circuit board; and
(b) a film detection apparatus connected to said pattern inspection apparatus for data communication therewith, said film detection apparatus acquiring information about said pattern detected by said pattern inspection apparatus as inspection region information, said film detection apparatus detecting whether or not an organic film is formed on said pattern,
said film detection apparatus including:
(b-1) a storage element for previously storing characteristic information serving as a reference;
(b-2) a holding element for holding an objective printed circuit board to be inspected;
(b-3) an illumination element for directing illuminating light onto said objective printed circuit board held by said holding element;
(b-4) an image capturing element for capturing an image of said objective printed circuit board irradiated with said illuminating light to provide two-dimensional image data;
(b-5) a detection element for detecting said organic film based on said image data provided from said image capturing element and said characteristic information stored in said storage element; and
(b-6) an output element for outputting a result of the detection of said detection element to an operator.

13. The inspection system according to claim 12, wherein
said inspection region information includes information about the shape and size of said pattern and the position of said pattern relative to said objective printed circuit board, and
said film detection apparatus determines an image capturing position of said image capturing element in accordance with said position of said pattern, and determines an imaging region of said image capturing element in accordance with said shape and size of said pattern.

14. A computer-readable program, said program being executed by a computer to cause said computer to perform the steps of:
(a) storing characteristic information serving as a reference;
(b) holding an objective printed circuit board to be inspected;
(c) directing illuminating light onto said objective printed circuit board held in said step (b);
(d) capturing an image of said objective printed circuit board irradiated with said illuminating light to provide two-dimensional image data;
(e) detecting an organic film on said objective printed circuit board based on said image data provided in said step (d) and said characteristic information stored in said step (a); and
(f) outputting a result of the detection provided in said step (e) to an operator.

15. The program according to claim 14, wherein
said step (e) includes the steps of:
(e-1) calculating a measured value inherent in said objective printed circuit board based on pixel values of predetermined pixels included in said image data;
(e-2) comparing said measured value with a predetermined threshold value included in said characteristic information; and
(e-3) judging whether said organic film is present or absent in accordance with a result of the comparison provided in step (e-2).

16. The program according to claim 15, wherein
said organic film is detected in said step (e) based on only a pixel value for light of a predetermined wavelength.

17. The program according to claim 15, wherein said computer is caused to further perform the step of
(g) specifying an inspection region of said objective printed circuit board,
wherein pixels of said image data include pixels corresponding to said inspection region, and
wherein said predetermined pixels are said pixels corresponding to said inspection region.

18. The program according to claim 15, wherein
said step (e) further includes the step of
(e-4) measuring the thickness of said organic film in accordance with said measured value if said organic film is detected in said step (e-3).

19. The program according to claim 14, wherein said computer is caused to further perform the step of
(h) displaying said image data captured in said step (d).

20. The program according to claim 14, wherein said computer is caused to further perform the steps of:
(i) detecting a pattern formed on a printed circuit board; and
G) generating information about said pattern detected in said step (i) as inspection region information, and
said organic film on said pattern is detected in accordance with said inspection region information in said step (e).

21. The program according to claim 20, wherein
said computer is caused to generate said inspection region information in said step (j) based on the position of said pattern on said objective printed circuit board, and the shape and size of said pattern, and
said computer is caused to further perform the steps of:
(k) determining an image capturing position in accordance with said position of said pattern; and
(l) determining an imaging region in accordance with said shape and size of said pattern.

22. A method of detecting an organic film formed on a printed circuit board formed with a pattern, said method comprising the steps of:
(a) previously storing characteristic information serving as a reference;
(b) holding an objective printed circuit board to be inspected;
(c) directing illuminating light onto said objective printed circuit board held in said step (b);
(d) capturing an image of said objective printed circuit board irradiated with said illuminating light to provide two-dimensional image data;
(e) detecting said organic film based on said image data provided in said step
(d) and said characteristic information stored in said step (a); and
(f) outputting a result of the detection provided in said step (e) to an operator.

23. The method according to claim 22, wherein
said step (e) includes the steps of:
(e-1) calculating a measured value inherent in said objective printed circuit board based on pixel values of predetermined pixels included in said image data;
(e-2) comparing said measured value with a predetermined threshold value included in said characteristic information; and
(e-3) judging whether said organic film is present or absent in accordance with a result of the comparison provided in step (e-2).

24. The method according to claim 23, wherein
said organic film is detected in said step (e) based on only a pixel value for light of a predetermined wavelength.

25. The method according to claim 23, further comprising the step of
(g) specifying an inspection region of said objective printed circuit board,
wherein pixels of said image data include pixels corresponding to said inspection region, and
wherein said predetermined pixels are said pixels corresponding to said inspection region.

26. The method according to claim 23, wherein
said step (e) further includes the step of
(e-4) measuring the thickness of said organic film in accordance with said measured value if said organic film is detected in said step (e-3).

27. The method according to claim 22, further comprising the step of
(h) displaying said image data captured in said step (d).

28. The method according to claim 22, wherein
said illuminating light is monochromatic light.

29. The method according to claim 22, wherein
said illuminating light is white light, and
said image data includes a color image.

30. A method of inspecting a printed circuit board, comprising the steps of:
(a) causing a pattern inspection apparatus to detect a pattern formed on a printed circuit board;
(b) generating inspection region information, said inspection region information being information about said pattern detected in said step (a);
(c) transmitting said inspection region information generated in said step (b) from said pattern inspection apparatus to a film detection apparatus; and
(d) causing said film detection apparatus to detect whether or not an organic film is formed on said pattern detected by said pattern inspection apparatus, based on said inspection region information transmitted in said step (c),
said step (d) including the steps of:
(d-1) previously storing characteristic information serving as a reference;
(d-2) holding an objective printed circuit board to be inspected;
(d-3) directing illuminating light onto said objective printed circuit board held in said step (d-2);
(d-4) capturing an image of said objective printed circuit board irradiated with said illuminating light to provide two-dimensional image data;
(d-5) detecting said organic film based on said image data provided in said step (d-4), said characteristic information stored in said step (d-1), and said inspection region information; and
(d-6) outputting a result of the detection provided in said step (d-5) to an operator.

31. The method according to claim 30, wherein
said inspection region information includes information about the shape and size of said pattern and the position of said pattern relative to said objective printed circuit board, and
an image capturing position is determined in accordance with said position of said pattern and an imaging region is determined in accordance with said shape and size of said pattern in said step (d-4).
